(19) United States
(12) Patent Application Publication
(10) Pub. No.: US 2008/0030307 A1
(43) Pub. Date: Feb. 7, 2008

(54) RFID TRANSPONDER

(75) Inventor: Chi-Bing Chen, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HOLTEK SEMICONDUCTOR INC., Hsinchu (TW)

(21) Appl. No.: 11/684,390

(22) Filed: Mar. 9, 2007

(30) Foreign Application Priority Data
Aug. 3, 2006 (TW) 095128554

(51) Int. Cl. H04Q 5/22

(52) U.S. Cl. 340/10.34

(57) ABSTRACT

A radio frequency identification (RFID) transponder is provided. The RFID transponder includes an LC resonant circuit having a first high frequency (HF) terminal and a second HF terminal, producing an AC signal, and transmitting a data; a full-wave rectifying circuit having a high voltage terminal, a low voltage terminal, a first terminal electrically connected to the first HF terminal, and a second terminal electrically connected to the second HF terminal, and rectifying the AC signal to a DC signal; and a first data modulating circuit having a third and a fourth terminals respectively electrically connected to the low voltage terminal and the second HF terminal, wherein the first data modulating circuit is coupled to a part of the full-wave rectifying circuit so that the transponder respectively transmits the data and is charged when the AC signal is respectively a negative AC signal and a positive AC signal.

### FIELD OF THE INVENTION

The present invention relates to an RIFD transponder. More particularly, the present invention relates to a passive RFID transponder applied to an integrated circuit.

### BACKGROUND OF THE INVENTION

As described in the U.S. Pat. No. 4,196,418, an early architecture of the radio frequency identification (RFID) transponder includes an LC resonant circuit and a data modulating load parallel thereto for modulating waveforms of data to be transmitted. The data modulating load could be selected from a group consisting of a set of switches, a set of switches in series with a load of inductance, and a set of switches in series with a load of capacitor, wherein the LC resonant circuit and an interrogator have the same resonance frequency.

Please refer to FIG. 1, which is the circuit diagram of a conventional RFID transponder provided by the U.S. Pat. No. 5,479,172, wherein the transponder 10 is primarily composed of an LC resonant circuit 101, a data modulating load R parallel thereto, and further an over-voltage protecting circuit 102.

Additionally, please refer to FIG. 2, which is the circuit diagram of another conventional RFID transponder provided by the U.S. Pat. No. 5,815,355, wherein a transponder 20 is similarly composed of an LTCT resonant circuit 201, a data modulating load parallel thereto, and further an over-voltage protecting circuit 202. The over-voltage protecting circuits 102 and 202 are respectively used in the two types of transponders 10 and 20 so as to avoid unobvious modulated AM signals due to load variations caused by the over-voltage protecting circuits 102 and 202 with a close distance between the interrogator and the transponder (10 or 20). The unobvious modulated AM signals would lead to occurrence of failure to signal identification.

It is a first problem encountered that the transponder must be coupled with electromagnetic waves and converted to the lowest operation voltage to begin the task of data transmission from a long to a short distance for contact of transmission between the interrogator and the transponder. However, based on the current architecture of the RFID transponder, the necessary modulating LC parallel to the resonant circuit for the interrogator to modulate the signals thereof would decrease power of received electromagnetic waves by the transponder.

Please refer to FIG. 3, which is a diagram showing the waveform between two terminals of the antenna of the RFID transponder in the prior art. The data 0 in the central portion represents the abovementioned decreased power of electromagnetic waves in FIG. 3. Accordingly, for the skilled person, a closer distance between the transponder and the interrogator must be achieved to increase the air coupling coefficient of electromagnetic waves so that the transponder could work normally.

In order to overcome the drawbacks in the prior art, an RFID transponder is provided. The particular design in the present invention not only solves the problems described above, but also is easy to be implemented. Thus, the invention has the utility for the industry.

### SUMMARY OF THE INVENTION

It is a first aspect of the present invention to provide a passive RFID transponder applied to an integrated circuit.

It is a second aspect of the present invention to provide an RFID transponder, wherein data are transmitted through the data load modulating method to increase a transmission distance between an RFID transponder and an interrogator.

It is a third aspect of the present invention to provide a radio frequency identification (RFID) transponder, comprising (a) an LC resonant circuit having a first high frequency (HF) terminal and a second HF terminal, producing an AC signal, and transmitting a data, (b) a full-wave rectifying circuit having a high voltage terminal, a low voltage terminal, a first terminal electrically connected to the first HF terminal, and a second terminal electrically connected to the second HF terminal, and rectifying the AC signal to a DC signal, and (c) a first data modulating circuit having a third and a fourth terminals respectively electrically connected to the low voltage terminal and the second HF terminal, wherein the first data modulating circuit is coupled to a part of the full-wave rectifying circuit so that the transponder respectively transmits the data and is charged when the AC signal is respectively a negative AC signal and a positive AC signal.

Preferably, the transponder further has a first inductor and a first capacitor parallel to each other between the first HF terminal and the second HF terminal.

Preferably, the full-wave rectifying circuit is a bridge rectifying circuit including a diode.

Preferably, the low voltage terminal is grounded, the negative AC signal is in a negative half cycle, and the positive AC signal is in a positive half cycle.

Preferably, the transponder further cooperates with an interrogator, wherein the LC resonant circuit further comprises a first inductor, the interrogator comprises a second inductor, and the AC signal is generated when the second inductor approaches the transponder.

Preferably, the transponder further comprises (a) an electric charge storage capacitor electrically connected to the high voltage terminal and the low voltage terminal and storing electric charges of the DC signal, (b) an over-voltage protecting circuit parallel to the electric charge storage capacitor for protecting the transponder, (c) a data storage device parallel to the over-voltage protecting circuit for storing the data, and (d) a digital controlling circuit coupled to the data storage device and the first data modulating circuit for determining an address for the data.

Preferably, the first data modulating circuit is a first transistor switch further having a first controlling terminal, and the first controlling terminal is electrically connected to the digital controlling circuit.

Preferably, the transponder further comprises a second data modulating circuit having a fifth and a sixth terminals, wherein the fifth and the sixth terminals are respectively electrically connected to the first HF terminal and the low voltage terminal.

Preferably, the second data modulating circuit assists an operation of the first data modulating circuit and includes a second transistor switch further having a second controlling terminal, and the second controlling terminal is electrically connected to the digital controlling circuit and controls the second data modulating circuit.

Preferably, the transponder further comprises a second data modulating circuit coupled between the low voltage terminal and the third terminal for assisting an operation of the first data modulating circuit.

Preferably, the second data modulating circuit is one selected from an inductor and a capacitor.

It is a fourth aspect of the present invention to provide an RFID transponder, comprising (a) an LC resonant circuit having a HF terminal and providing an AC signal, (b) a rectifying circuit comprising a low voltage terminal and rectifying the AC signal to a DC signal, and (c) a first data modulating circuit having two ends respectively electrically connected to the low voltage and the HF terminals, wherein the transponder respectively transmits a data and is charged when the AC signal is respectively a negative AC signal and a positive AC signal.

Preferably, the rectifying circuit is a full-wave rectifying circuit.

It is a fifth aspect of the present invention to provide an RFID transponder, comprising (a) an LC resonant circuit having a first high frequency (HF) terminal and a second HF terminal, producing an AC signal, and transmitting a data, (b) a full-wave rectifying circuit having a high voltage terminal, a low voltage terminal, a first terminal electrically connected to the first HF terminal, and a second terminal electrically connected to the second HF terminal, and rectifying the AC signal to a DC signal (c) a first data modulating circuit having a third and a fourth terminals respectively electrically connected to the low voltage terminal and the second HF terminal, (d) an electric charge storage capacitor electrically connected to the high voltage terminal and the low voltage terminal and storing electric charges of the DC signal, (e) an over-voltage protecting circuit parallel to the electric charge storage capacitor for protecting the transponder, (f) a data storage device parallel to the over-voltage protecting circuit for storing the data, and (g) a digital controlling circuit coupled to the data storage device and the first data modulating circuit for determining an address for the data.

Preferably, the full-wave rectifying circuit is a bridge rectifying circuit including a diode.

Preferably, the low voltage terminal is grounded, the negative AC signal is in a negative half cycle, and the positive AC signal is in a positive half cycle.

Preferably, the transponder further cooperates with an interrogator, wherein the LC resonant circuit further comprises a first inductor, the interrogator comprises a second inductor and the AC signal is generated when the second inductor approaches the transponder.

Preferably, the first data modulating circuit is a first transistor switch further having a first controlling terminal, and the first controlling terminal is electrically connected to the digital controlling circuit.

Preferably, the transponder further comprises a second data modulating circuit having a fifth and a sixth terminals, wherein the fifth and the sixth terminals are respectively electrically connected to the first HF terminal and the low voltage terminal.

Preferably, the second data modulating circuit assists an operation of the first data modulating circuit and includes a second transistor switch further having a second controlling terminal, and the second controlling terminal is electrically connected to the digital controlling circuit and controls the second data modulating circuit.

Preferably, the transponder further comprises a second data modulating circuit coupled between the low voltage terminal and the third terminal for assisting an operation of the first data modulating circuit.

Preferably, the second data modulating circuit is one selected from an inductor and a capacitor.

Other objects, advantages and efficacies of the present invention will be described in detail below taken from the preferred embodiments with reference to the accompanying drawings, in which:

### BRIEF DESCRIPTION OF THE DRAWINGS

FIG. 1 is the circuit diagram of a conventional RFID transponder provided by the U.S. Pat. No. 5,479,172;

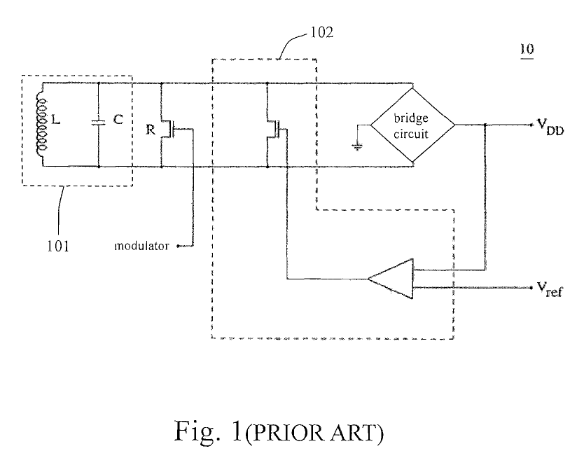

FIG. 2 is the circuit diagram of another conventional RFID transponder provided by the U.S. Pat. No. 5,815,355;

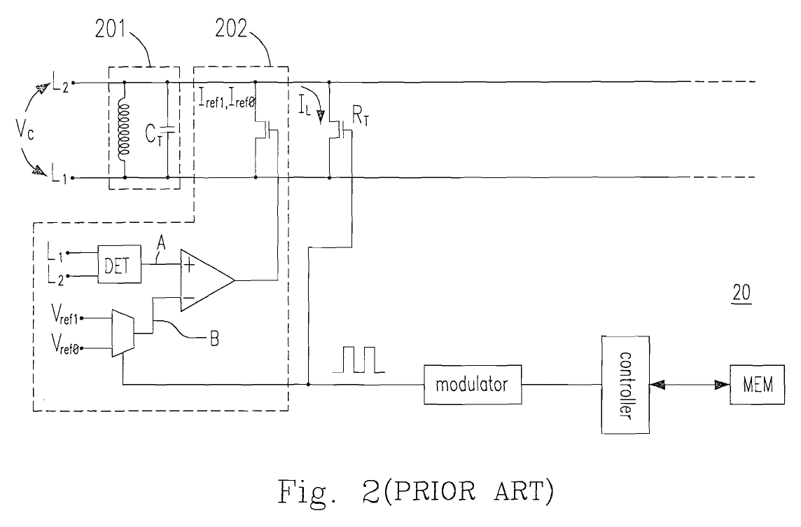

FIG. 3 is a diagram showing the waveform between two terminals of the antenna of the RFID transponder in the prior art;

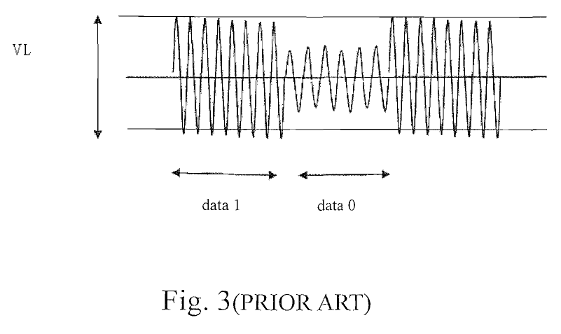

FIG. 4 is a circuit diagram of the RFID transponder according to a first preferred embodiment of the present invention;

FIG. 5 is a diagram showing the waveform between two terminals of the antenna of the transponder according to a preferred embodiment of the present invention;

FIG. 6 is a circuit diagram of the RFID transponder according to a second preferred embodiment of the present invention;

FIG. 7 is a circuit diagram of the RFID transponder according to a third preferred embodiment of the present invention; and

FIG. 8 is a circuit diagram of the RFID transponder according to a fourth preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

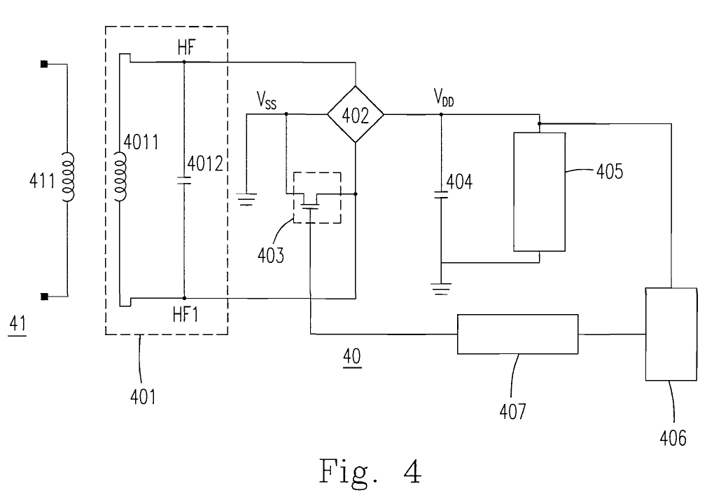

Please refer to FIG. 4, which is a circuit diagram of the RFID transponder according to a first preferred embodiment of the present invention, wherein the transponder 40 is primarily composed of an LC resonant circuit 401, a full-wave rectifying circuit 402, and a first data modulating circuit 403. The LC resonant circuit 401 includes a first high frequency terminal HF and a second high frequency terminal HF1 and comprises an inductance 4011 and a capacitor 4012 parallel to each other therebetween. Besides, the full-wave rectifying wave 402 has a first end, a second end, a third end, and a forth end respectively connected to a high voltage terminal V_{DD}, a low voltage terminal V_{SS}, the first HF terminal, and the second HF1 terminal. Furthermore, the first data modulating circuit 403 has a first end and a second end respectively connected to the low voltage terminal V_{SS} and the second high frequency terminal HF1. Compared with the conventional transponder circuit architecture, rather than being parallel to the LC resonant circuit 401, the data modulating circuit 403 is configured between the second high frequency terminal HF1 and the low voltage terminal V_{SS} without any other data modulating circuits directly parallel to the LC resonant circuit 401 on two sides thereof.

In the present embodiment, the high voltage terminal V_{DD} is the high voltage power supply for the integrated circuit including the transponder 40, and the full-wave rectifying circuit 402 is a bridge rectifying circuit composed of a diode (not shown) for rectifying an AC signal from the LC resonant circuit 401 to a DC signal. In the application of radio frequency identification (RFID), there is a transponder 40 cooperating with an interrogator 41, wherein the interrogator 41 has a second inductance 411 to generate the ac signal upon the approach thereof to the LC resonant circuit 411. Additionally, the first data modulating circuit 403 is composed of a transistor switch, wherein the two ends instead of the controlling end thereof are respectively connected to the low voltage terminal V_{SS} and the second high frequency terminal HF1.

The main operation principles of the transponder 40 in the present invention are described hereafter. From a long distance to a short distance for the contact transmission between the interrogator 41 and the transponder 40, the first inductance 4011 between the first high frequency terminal HF and the second high frequency terminal HF1 would be coupled with energy of the second inductance 411 in the interrogator 41 to generate the AC signal, defined as an HF_HF1 voltage, wherein the intra-operation of the transponder 40 under circumstances of the HF_μHF1 voltage in the respective positive half and negative half cycles is described as follows.

When the HF_HF1 voltage is in the negative half cycle, the transistor switch of the first data modulating circuit 403 would be coupled with the diode in series between the first high frequency terminal HF and the low voltage terminal V_{SS}, wherein the constituted coupling circuit would be parallel to the LC resonant circuit 401 at two sides thereof. Accordingly, when the transistor switch of the first data modulating circuit 403 is on or off, there would exist a load respectively close to a short or an open circuits parallel to the LC resonant circuit 401 at the two sides thereof. As a result, data between the transponder 40 and the interrogator 41 could be transmitted utilizing the AM modulation by means of the variations of the quality factor of resistor-capacitor-inductance (RCL).

When the HF_HF1 voltage is in the positive half cycle, the potential difference between the second high frequency terminal HF1 and the low voltage terminal V_{SS} would not change much, whether the transistor switch of the first data modulating circuit 403 is on or off, because the transistor switch of the first data modulating circuit 403 would be coupled in parallel with the diode between the first high frequency terminal HF and the low voltage terminal V_{SS}, and the diode between the second high frequency terminal HF1 and the low voltage terminal V_{SS} would be on. In other words, the voltage waveforms of the LC resonant circuit 401 would hardly be affected no matter the transistor switch of the first data modulating circuit 403 is on or not, wherein there would be a load close to a short circuit parallel to the LC resonant circuit 401 at the two sides thereof simultaneously; accordingly, the transponder 40 constantly charges during this period without being affected by the modulated data to be transmitted.

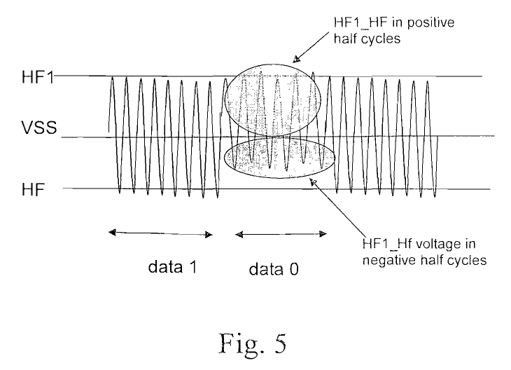

Please refer to FIG. 5, which is a diagram showing the waveform between two terminals of the antenna of the transponder according to a preferred embodiment of the present invention. Based on the above, the architecture proposed by the present invention could effectively increase the transmission distance between the interrogator 41 and the transponder 40.

Please still refer to FIG. 4, wherein the RFID transponder 40 further includes such circuit components as a charge storing capacitor 404, an over-voltage protecting circuit 405, a data storing device 406, and a digital controlling circuit 407.

Furthermore, the charge storing capacitor 404 is electrically connected to the high voltage terminal V_{DD} and the low voltage terminal V_{SS} by two respective ends thereof for storing charges of the DC signals from the full-wave rectifying circuit. Besides, the over-voltage protecting circuit 405 is parallel to the charge storing capacitor 404 for preventing the excessively high voltage caused by the short transmission distance between the interrogator 41 and the transponder 40. On the other hand, the data storing device 406 could be a memory such as an electrically erasable programmable read-only memory (EEPROM) or an erasable programmable read-only memory (EPROM), which is parallel to the over-voltage protecting circuit 405 for storing the data to be transmitted by the transponder 40. The digital controlling circuit 407 is coupled with the data storing device 406 and the controlling end of the transistor switch in the first data modulating circuit 403 for determining an address of the data to be transmitted by the transponder 40.

Regarding the components of the transponder 40 in the present invention, the operation principles thereof are described hereafter. When the distance between the interrogator 41 and the transponder 40 varies from long to short, wherein a distance between the inductance 411 and the inductance 4011 varies correspondingly from long to short, the integrated circuit of the transponder 40 would fail to obtain power for the minimal operation voltage if the distance is excessively long which causes an excessively low air coupling coefficient.

Contrarily, when the distance between the interrogator 41 and the transponder 40 varies from long to short, resulting in a sufficiently small distance between the inductances 411 and 4011, the transponder 40 would be coupled with the interrogator 41 based on the principle of the transformer to generate an AC signal, which would be rectified to the DC signal by the full-wave rectifying circuit 402, and the charges of the generated DC signal would be stored in the charge storing capacitor 404. When the voltage in the charge storing capacitor 407 reaches the minimal operation voltage for the integrated circuit, the data storing device 406 would manage to transmit data, and the digital controlling circuit 407 would adjust the transistor switch of the first data modulating circuit 403 to enable the transponder 40 to transmit data.

As abovementioned, the charge storing capacitor 404 could constantly charge in the positive half cycle of the voltage HF_HF1 no matter the transistor switch of the first data modulating circuit 403 in the transponder 40 is on or off. Consequently, termination of charging for the charge storing device 404 and failure to maintain the minimal operation voltage for the integrated circuit arising from transmitting the conduction signal to modulate the data modulating device 403 in the prior art could be thus avoided. Therefore, the data transmission would hardly meet failure, and the transmission distance could be effectively raised.

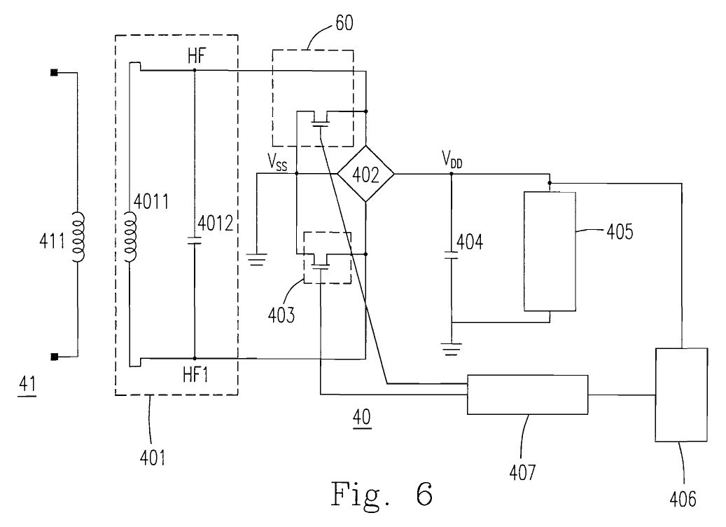

Please refer to FIG. 6, which is a circuit diagram of the RFID transponder according to a second preferred embodiment in the present invention, where the circuit components the same as those in FIG. 4 are all labeled with the same reference numerals. The circuit of FIG. 6 differs from that of FIG. 4 in that a second data modulating circuit 60 is further connected between the first frequency terminal HF and the low voltage terminal V_{SS} for assisting the operation of the first data modulating circuit 403.

In the second preferred embodiment, the second data modulating circuit 60 is also composed of a transistor switch, which is connected between the first high frequency terminal HF and the low voltage terminal V_{SS} and further includes a controlling end connected to the digital controlling circuit 407, so that the second data modulating circuit 60 could coherently be involved in the signal by AM modulation. Regarding the remaining circuit components, the operations thereof are all the same as those in FIG. 4.

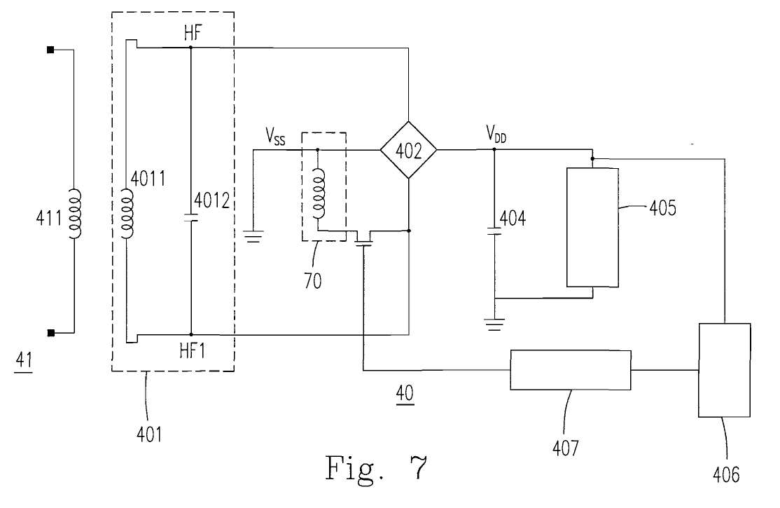

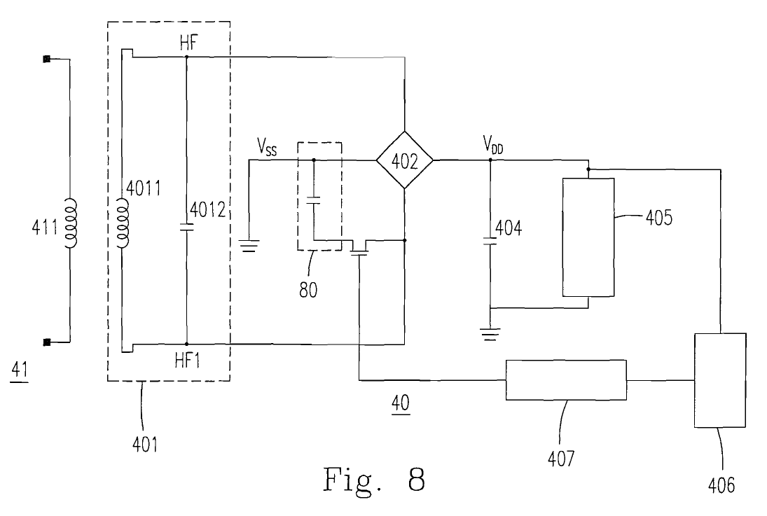

Please refer to FIG. 7, which is a circuit diagram of the RFID transponder according to a third preferred embodiment in the present invention, where the circuit components the same as those in FIG. 4 are all labeled with the same reference numerals. The circuit of FIG. 7 differs from that of FIG. 4 in that a third data modulating circuit 70 is further connected between the low voltage terminal V_{SS} and the end of the first data modulating circuit 403 originally connected thereto for assisting the operation of the first data modulating circuit 403. In this embodiment, the third data modulating circuit 70 includes an inductance load, which can also be replaced by a capacitor load 80 as shown in FIG. 8.

Regarding the remaining circuit components in FIGS. 7 and 8, the operations thereof are the same as those in FIG. 4.

To summarize, a passive RFID transponder is provided in the present invention to transmit data through the modulation of data load, wherein the data modulating circuit could selectively be coupled with the LC resonant circuit by adjusting the switch based on the modification of the data modulating circuit connected in parallel with the LC resonant circuit at two sides thereof in the prior art. Furthermore, not only the efficiency of transformation from the electromagnetic waves to the necessary power for the transponder is raised, but also the transmission distance between the interrogator and the transponder is effectively increased.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A radio frequency identification (RFID) transponder, comprising:
an LC resonant circuit having a first high frequency (HF) terminal and a second HF terminal, producing an AC signal, and transmitting a data;
a full-wave rectifying circuit having a high voltage terminal, a low voltage terminal, a first terminal electrically connected to the first HF terminal, and a second terminal electrically connected to the second HF terminal, and rectifying the AC signal to a DC signal; and
a first data modulating circuit having a third and a fourth terminals respectively electrically connected to the low voltage terminal and the second HF terminal,
wherein the first data modulating circuit is coupled to a part of the full-wave rectifying circuit so that the transponder respectively transmits the data and is charged when the AC signal is respectively a negative AC signal and a positive AC signal.

2. A transponder as claimed in claim 1, further having a first inductor and a first capacitor parallel to each other between the first HF terminal and the second HF terminal.

3. A transponder as claimed in claim 1, wherein the full-wave rectifying circuit is a bridge rectifying circuit including a diode.

4. A transponder as claimed in claim 1, wherein the low voltage terminal is grounded, the negative AC signal is in a negative half cycle, and the positive AC signal is in a positive half cycle.

5. A transponder as claimed in claim 1, further cooperating with an interrogator, wherein the LC resonant circuit further comprises a first inductor, the interrogator comprises a second inductor, and the AC signal is generated when the second inductor approaches the transponder.

6. A transponder as claimed in claim 1, further comprising:
an electric charge storage capacitor electrically connected to the high voltage terminal and the low voltage terminal and storing electric charges of the DC signal;
an over-voltage protecting circuit parallel to the electric charge storage capacitor for protecting the transponder;
a data storage device parallel to the over-voltage protecting circuit for storing the data; and
a digital controlling circuit coupled to the data storage device and the first data modulating circuit for determining an address for the data.

7. A transponder as claimed in claim 6, wherein the first data modulating circuit is a first transistor switch further having a first controlling terminal, and the first controlling terminal is electrically connected to the digital controlling circuit.

8. A transponder as claimed in claim 7, further comprising a second data modulating circuit having a fifth and a sixth terminals, wherein the fifth and the sixth terminals are respectively electrically connected to the first HF terminal and the low voltage terminal.

9. A transponder as claimed in claim 8, wherein the second data modulating circuit assists an operation of the first data modulating circuit and includes a second transistor switch further having a second controlling terminal, and the second controlling terminal is electrically connected to the digital controlling circuit and controls the second data modulating circuit.

10. A transponder as claimed in claim 7 further comprising a second data modulating circuit coupled between the low voltage terminal and the third terminal for assisting an operation of the first data modulating circuit.

11. A transponder as claimed in claim 10, wherein the second data modulating circuit is one selected from an inductor and a capacitor.

12. An RFID transponder, comprising:
an LC resonant circuit having a HF terminal and providing an AC signal;
a rectifying circuit comprising a low voltage terminal and rectifying the AC signal to a DC signal; and
a first data modulating circuit having two ends respectively electrically connected to the low voltage and the HF terminals,
wherein the transponder respectively transmits a data and is charged when the AC signal is respectively a negative AC signal and a positive AC signal.

13. A transponder as claimed in claim 12, wherein the rectifying circuit is a full-wave rectifying circuit.

14. An RFID transponder, comprising:
an LC resonant circuit having a first high frequency (HF) terminal and a second HF terminal, producing an AC signal, and transmitting a data;
a full-wave rectifying circuit having a high voltage terminal, a low voltage terminal, a first terminal electrically connected to the first HF terminal, and a second terminal electrically connected to the second HF terminal, and rectifying the AC signal to a DC signal;
a first data modulating circuit having a third and a fourth terminals respectively electrically connected to the low voltage terminal and the second HF terminal;
an electric charge storage capacitor electrically connected to the high voltage terminal and the low voltage terminal and storing electric charges of the DC signal;
an over-voltage protecting circuit parallel to the electric charge storage capacitor for protecting the transponder;
a data storage device parallel to the over-voltage protecting circuit for storing the data; and
a digital controlling circuit coupled to the data storage device and the first data modulating circuit for determining an address for the data.

15. A transponder as claimed in claim 14, wherein the full-wave rectifying circuit is a bridge rectifying circuit including a diode.

16. A transponder as claimed in claim 14, wherein the low voltage terminal is grounded, the negative AC signal is in a negative half cycle, and the positive AC signal is in a positive half cycle.

17. A transponder as claimed in claim 14, further cooperating with an interrogator, wherein the LC resonant circuit further comprises a first inductor, the interrogator comprises a second inductor and the AC signal is generated when the second inductor approaches the transponder.

18. A transponder as claimed in claim 14, wherein the first data modulating circuit is a first transistor switch further having a first controlling terminal, and the first controlling terminal is electrically connected to the digital controlling circuit.

19. A transponder as claimed in claim 18, further comprising a second data modulating circuit having a fifth and a sixth terminals, wherein the fifth and the sixth terminals are respectively electrically connected to the first HF terminal and the low voltage terminal.

20. A transponder as claimed in claim 19, wherein the second data modulating circuit assists an operation of the first data modulating circuit and includes a second transistor switch further having a second controlling terminal, and the second controlling terminal is electrically connected to the digital controlling circuit and controls the second data modulating circuit.

21. A transponder as claimed in claim 18 further comprising a second data modulating circuit coupled between the low voltage terminal and the third terminal for assisting an operation of the first data modulating circuit.

22. A transponder as claimed in claim 21, wherein the second data modulating circuit is one selected from an inductor and a capacitor.
